(19) United States
(12) Patent Application Publication
(10) Pub. No.: US 2013/0006914 A1
(43) Pub. Date: Jan. 3, 2013

(54) EXPOSING SEARCH HISTORY BY CATEGORY

(75) Inventors: Paul Ronald Ray, REDMOND, WA (US); Laura Jean Kern, SEATTLE, WA (US); Michael Austin Schechter, SAMMAMISH, WA (US)

(73) Assignee: MICROSOFT CORPORATION, REDMOND, WA (US)

(21) Appl. No.: 13/170,278

(22) Filed: Jun. 28, 2011

(51) Int. Cl. G06F 17/30; G06N 5/04

(52) U.S. Cl. 706/50; 707/738; 707/E17.046

(57) ABSTRACT

Computer-storage media, methods, and systems for mapping a previously submitted query to category(s) and for rendering the category(s) in visual association with the query are provided. Generally, the query is assigned the category(s) by employing one or more categorization processes. One categorization process involves selecting entity(s) that capture a topic inherent to the query, identifying the category(s) that encompass the subject matter of the entity(s), respectively, and generating a mapping between the identified category(s) and the query. Here, the entity(s) operate as a semantic representation of the query. Another categorization process involves inferring a logical description underlying the query, and identifying specific and general category(s) that are semantically related to the inferred logical description. Upon detecting an indication to view past queries, any combination of the specific category, the general category, and the query mapped thereto is presented concurrently to the user.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Presently, the Internet provides a vast variety of utilities that assist Internet searching for information. Typically, searching for information involves a user initiating a query or request for the information at the web browser running on the user's local computing device. In response to the query, a search engine running on a remote server gathers and delivers the requested information to the web browser in the form of search results. These search results are often presented on a search-results page and may or may not satisfy the searching intent of the query upon the user's review.

If one or more of the search results do, in fact, satisfy the user's searching intent underlying the query, the user may be inclined to be prompted with the key words or terms of the query when the occasion arises to again conduct a search for those search results that the user had deemed satisfactory. However, it is documented that users are reluctant to spend time manually saving a query and the context of the query. As a result, approximately half of all submitted queries reflect a repeat of a previous query (either exactly or similar) entered by a user that achieved fruitful search results.

Currently, conventional search engines offer ways to store and recall specific queries that the user has entered in the past. However, these specific queries are not offered to the user in a helpful way that would increase searching efficiencies or improve the user's overall searching experience. As such, employing emerging technologies to map queries with categories and display them concurrently provides a competitive advantage for the search engine and would enhance the user's ability to quickly comprehend the context surrounding previously submitted queries and to properly remember whether or not the queries proved to be successful. As a result, the user's general opinion of the search engine is improved, thereby converting the user into a loyal customer of the service that operates the search engine.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer-storage media for improving the ability of a user to revisit a set of search results that the user deemed helpful when conducting a search in a given context. Generally, the technology employed by these embodiments resides in the search-history space, where previous queries (e.g., search terms drawn from a log of search history produced by the user) are selected for presentation to the user in an innovative format. In one instance, this technology carries out a mapping between a previous query and general and/or specific categories, where the mapping may be maintained for a predetermined amount of time.

When conducting a searching session, the previous query and the category(s) mapped thereto may be presented to the user in concurrence, such that the user is offered some context surrounding the previous query. In this way, because the user is informed of the categories mapped to the previous search, as well as those other previous searches that are determined to be encompassed by the categories, the user is better positioned to recall which query in a given context generated the most relevant search results. Further, in other embodiments, the user may refine the context surrounding the previous query by modifying, creating, or deleting the categories that were initially mapped thereto.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a schematic diagram of an exemplary system architecture suitable for use in implementing embodiments of the present invention, in accordance with an embodiment of the present invention;

FIG. 3 is a schematic diagram depicting a first illustrative UI display of a homepage configured for accepting a query from a user, in accordance with embodiments of the invention;

FIG. 4 is a schematic diagram depicting a second illustrative UI display of a primary category page showing a taxonomy of categories, in accordance with embodiments of the invention;

FIG. 5 is a schematic diagram depicting a third illustrative UI display of a secondary category page showing queries in visual association with a category, in accordance with embodiments of the invention;

FIG. 6 is a flow diagram illustrating an overall method for mapping a query to a category, in accordance with an embodiment of the present invention; and

FIG. 7 is a flow diagram illustrating an overall method for presenting one or more categories in visual association with a query on a UI display, in accordance with an embodiment of the present invention.

### DETAILED DESCRIPTION

The subject matter of embodiments of the invention disclosed herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies.

Generally, embodiments of the present invention pertain to a system and method for assisting a user in rediscovering search results that satisfied the underlying searching intent of a previously submitted query. As can be gleaned from the above statement, various embodiments of the present invention involve retrieving search results, or other requested information, upon issuing a query. Often, the search results are generated and surfaced on a user-interface (UI) display through the employment of task-based engines (e.g., decision engines, task engines, individual applications or operations, applet systems, operating systems, and task-based mobile systems), or general systems that allow a user to accomplish tasks by matching apps to user intent. For simplicity of discussion, these engines and/or systems will be hereinafter referred to as “search engines.”

Accordingly, in one aspect, the present invention provides one or more computer-storage media having computer-executable instructions embodied thereon that, when executed, perform a method for mapping a query to a category. In embodiments, the method involves detecting the query being submitted by a user at a first UI display. The query may be assigned one or more categories via a categorization process. Generally, the categorization process involves at least the following steps: selecting at least one entity that corresponds to a topic inherent to the query, identifying the category(s) that encompass subject matter of the entity(s), respectively; and generating a mapping between the identified category(s) and the query. Typically, the entity(s) operate as a semantic representation of the query. The method may further involve maintaining a record in a log of the user's search history of the mapping between the identified category(s) and the query.

In another aspect, a computerized method is provided for presenting one or more categories in visual association with a query on a UI display. In embodiments, the method includes the steps of targeting the query within a log of a user's search history and parsing the targeted query to infer a logical description underlying the targeted query. In operation, the inferred logical description of the targeted query may be compared against a taxonomy of categories.

Upon comparison, a specific category may be identified that is semantically related to the inferred logical description of the targeted query. Further, a general category may be identified that is also semantically related to the inferred logical description of the targeted query. However, the general category resides at a different hierarchical level within the taxonomy than the specific category. The method may further include, incident to receiving a request from a user, rendering the targeted query in visual association with the specific category.

In yet another embodiment of the present invention, a computer system is provided for recognizing and presenting one or more categories that capture a semantic meaning of a query. By way of system architecture, the computer system comprises a processing unit coupled to a computer storage medium that stores a plurality of computer software components executable by the processing unit. The computer software components may include a query categorizer, a rendering component, a user experience (UX) layer, and an editing component. In embodiments, the query categorizer is configured for selecting the categories that are associated with the query received from a user. Often, the selected categories include a specific category that narrowly encompasses the semantic meaning of the query and a general category that broadly encompasses the semantic meaning of the query. The rendering component is configured for determining whether to present the selected categories as a function of a number of queries that are previously associated therewith.

Generally, the categories from which the query categorizer targets the selected category are generated from a user's previous queries. These previous queries may be included within a dynamically updatable search history associated with the user. The search history, as will be discussed more fully below, is stored in data store(s) such that the queries are accessible on demand from other components within the system architecture. During access, the queries may be located by linking them to a user ID and inspecting the data store(s) with the user ID of the user.

The UX layer is configured for, inter alfa, presenting a representation of the query in conjunction with the selected categories at a category page. Typically, the step of presenting is instructed upon determining that the number of queries that are previously associated with the selected categories overcomes a predefined threshold. As more fully discussed below, the query representation includes a link that, when actuated, navigates the user to a search-results page via a search engine. The editing component is configured for allowing the user to add, delete, and alter the queries previously associated with the selected categories.

Having briefly described an overview of embodiments of the present invention and some of the elements featured therein, an exemplary operating environment suitable for implementing the present invention is described below.

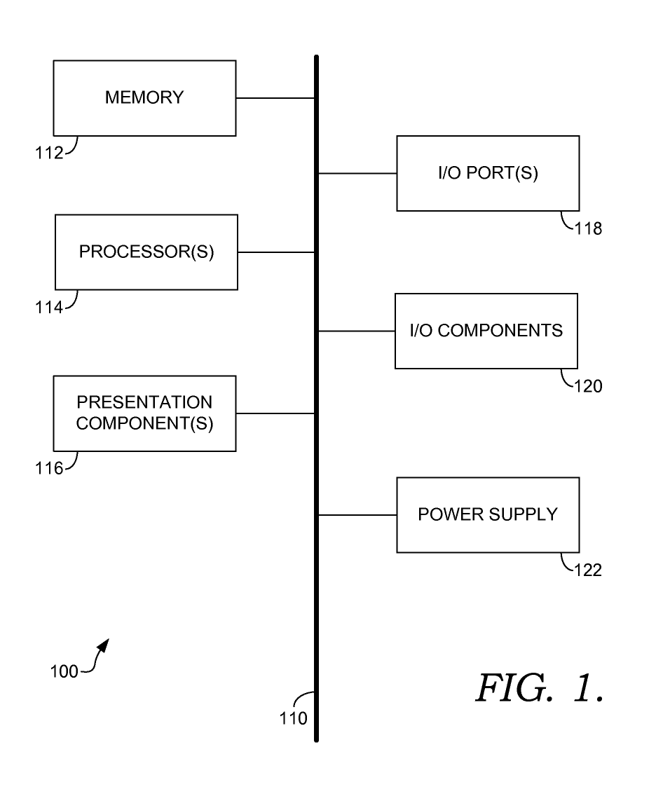

Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that performs particular tasks or implements particular abstract data types. The invention may be practiced in a variety of system configurations, including handheld devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output (I/O) ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and nonremovable media. By way of example, and not limitation, computer-readable media may comprise computer storage media and communication media. Computer storage media include both volatile and nonvolatile, removable and nonremovable media implemented in any method or technology for storage of information such as computer-readable instructions, data structures, program modules, or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium, which can be used to store the desired information and which can be accessed by computing device 100. Communication media typically embody computer-readable instructions, data structures, program modules or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

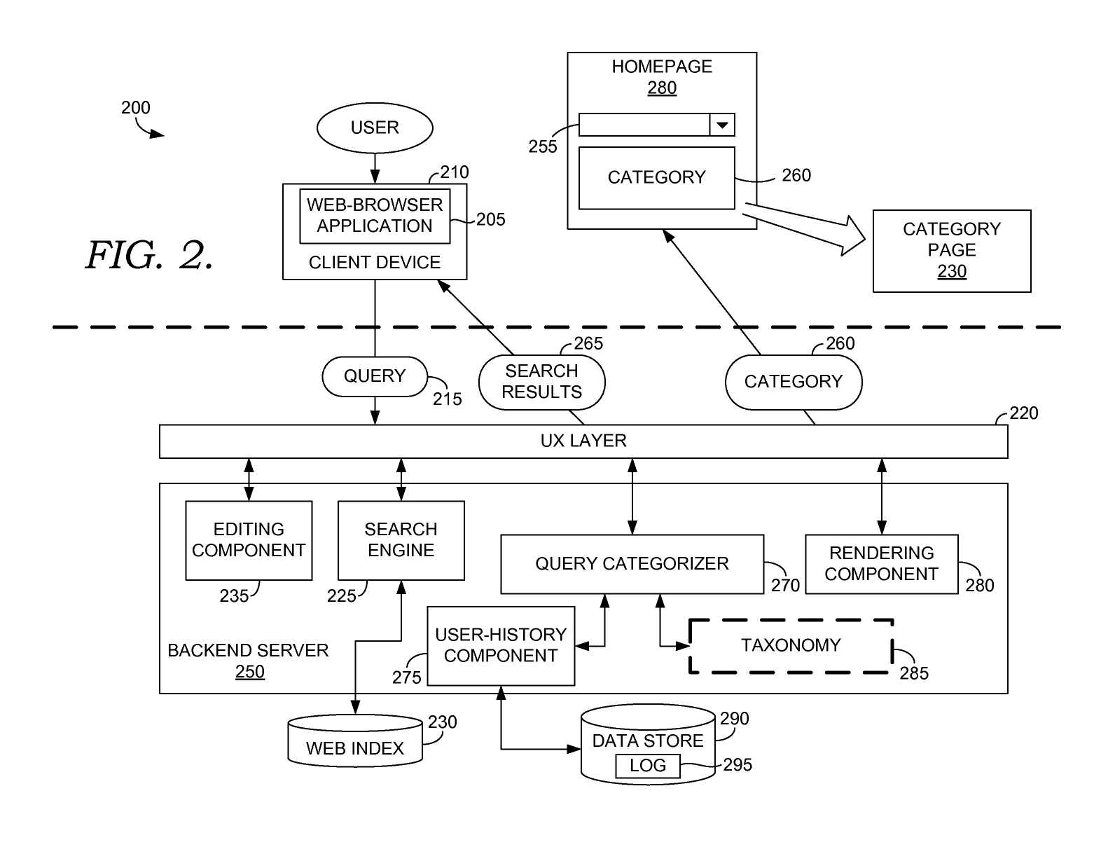

Technology introduced by embodiments of the present invention for automatically mapping one or more categories to a previously submitted query and presenting the category(s) concurrently with the query will now be discussed with reference to FIG. 2. Generally, this technology employs a variety of techniques to help disambiguate user intent during a search event and to leverage the user intent distilled from previous queries to pair those queries with one or more predefined categories. In particular, one of these techniques involves determining the entity in which a previous query semantically corresponds. Upon matching the query with one or more entities corresponding thereto, those entities may be used to determine one or more candidate categories, from a taxonomy of predefined categories, that are related to the subject matter inherent to the corresponding entities. Thus, the techniques described below help match one or more predefined, candidate categories with the previous query such that the user-intent disambiguation techniques for making the match are sufficiently transparent to the user.

In exemplary embodiments, a variety of abstract objects (e.g., entities, entity classes, and entity domains) are employed to recognize a logical correlation between the search terms of a query and one or more categories (e.g., specific and general categories) with a pre-established taxonomy. Generally, these “abstract objects” refer to semantic descriptions of topics, themes, subject matter, etc., which cannot be adequately managed through the use of matching keywords alone. That is, abstract objects consider the context of a user's query, which exposes the user's true searching intent, as opposed to employing just keyword-matching techniques, which do not always accurately target the user's searching intent. As used herein, the term “entities” generally refers to logical objects that may be represented by a particular semantic description. These logical objects may be a person, place, thing, or any combination thereof. For instance, some examples of logical objects are the following: the movie Avatar; the restaurant Shiva' s in Mountain View, Calif.; the sports team the Seattle Seahawks®; the company of Microsoft™; and the charity of Red Cross®.

Another type of abstract object used to monetize a search event is “entity classes,” which generally refer to a set of entities that share a common property. For example, “entity classes” include sets of entities grouped by one or more shared properties or parameters, such as movies; restaurants; sports teams; companies; and charities. In operation, when the user's search intent parsed from the search terms of a query points to an entity class (e.g., associated with a general category), those specific entities (e.g., associated with specific categories) within the purview of the entity class would also be relevant to the query. Embodiments of the present invention further allow for employing the entities or entity classes to determine which hierarchical levels of categories within the taxonomy are to be selected for association with the query.

By way of example, if it is determined that the user's query targets the entity “Hasselbeck injury status” when conducting an online search, the system of the present invention may elect to match the targeted entity to the specific category of the “sports team the Seattle Seahawks.” This occurs because the most probable semantic meaning of Has selbeck, based on the search data collected by the search engine, relates to the current quarterback of the Seattle Seahawks. In contrast a rigid key-word matching scheme would fail to recognize this association and would likely return search results that were irrelevant to the user's true searching intent.

If, upon examination of the user's search history, it is determined there exists minimal to no other previous queries that are semantically related to the specific category in the example above, the system may select and display the general category of “sports teams,” which likely topically corresponds with a greater number of queries within the user's search history. In this way, the system attempts to find the best fit between the entity or entity class of the targeted query in conjunction with other past queries. Thus, by broadening the scope of the category(s) assigned to the query, any criteria that require a minimum number of queries be associated with a category before the category is approved for rendering has an increased chance of being satisfied.

If there exists an insufficient number of queries within the search history to meet the minimum-number criteria, the scope of the category may be expanded to encompass a greater amount of material. Likewise, the entity classes may be broadly categorized to form entity domains, which reside on a higher level of abstraction than entity classes. These “entity domains” represent general groupings covering a wide scope of entities and serve as general divisions between the entity classes. For example, entity domains may include, but are not limited to, the following examples: sports, locations, transportation, and shopping. Accordingly, entity domains represent the highest-level classifier of entities within the hierarchy of entity domains, entity classes, and individual entities. Thus, in operation, the system may employ one or more of the entity domains, entity classes, and/or individual entities to glean the user's searching intent underlying the query and find the appropriate categories within the taxonomy.

Turning now to FIG. 2, a block diagram is depicted that illustrates an exemplary system architecture 200 of a distributed computing environment, suitable for use in implementing embodiments of the present invention. Generally, implementing embodiments of the present invention relate to improving a users' ability to retrace steps that navigated the user to a valuable search result (e.g., web page, website, online document, or other online destination) by providing a structure of categories. Sequential selection of the categories from general to specific allows the user to drill down to a query that previously directed the user to the valuable search result. Accordingly, the user is saved the frustrating experience of randomly guessing at queries, or repeatedly typing a query, in order to rediscover the valuable search result. It should be understood and appreciated that the exemplary system architecture 200 shown in FIG. 2 is merely an example of one suitable computing environment and is not intended to suggest any limitation as to the scope of use or functionality of the present invention. Neither should the exemplary system architecture 200 be interpreted as having any dependency or requirement related to any single component or combination of components illustrated therein.

Initially, the exemplary system architecture 200 includes a client device 210, a UX layer 220, a backend server 250, a web index 230, data store(s) 290, and a network (not shown) that interconnects each of these items. Each of the client device 210, the UX layer 220, the backend server 250, the web index 230, and the data store(s) 290 shown in FIG. 2, may take the form of various types of computing devices, such as, for example, the computing device 100 described above with reference to FIG. 1. By way of example only and not limitation, the client device 210 and/or the backend server 250 may be a personal computer, desktop computer, laptop computer, consumer electronic device, handheld device (e.g., personal digital assistant), various servers, processing equipment, and the like. It should be noted, however, that the invention is not limited to implementation on such computing devices but may be implemented on any of a variety of different types of computing devices within the scope of embodiments of the present invention.

Typically, each of the devices 210 and 250 includes, or is linked to, some form of computing unit (e.g., central processing unit, microprocessor, etc.) to support operations of the component(s) running thereon (e.g., search engine 225, editing component 235, and the like). As utilized herein, the phrase “computing unit” generally refers to a dedicated computing device with processing power and storage memory, which supports operating software that underlies the execution of software, applications, and computer programs thereon. In one instance, the computing unit is configured with tangible hardware elements, or machines, that are integral, or operably coupled, to the devices 210 and 250 to enable each device to perform communication-related processes (e.g., interfacing with the data store 290 to access a log 295 of the user's search history) and other operations (e.g., employing the query categorizer 270 to furnish a list of candidate categories derived from the user's search history). In another instance, the computing unit may encompass a processor (not shown) coupled to the computer-readable medium accommodated by each of the devices 210 and 250.

Generally, the computer-readable medium includes physical memory that stores, at least temporarily, a plurality of computer software components that are executable by the processor. As utilized herein, the term “processor” is not meant to be limiting and may encompass any elements of the computing unit that act in a computational capacity. In such capacity, the processor may be configured as a tangible article that processes instructions. In an exemplary embodiment, processing may involve fetching, decoding/interpreting, executing, and writing back instructions.

Also, beyond processing instructions, the processor may transfer information to and from other resources that are integral to, or disposed on, the devices 210 and 250. Generally, resources refer to software components or hardware mechanisms that enable the devices 210 and 250 to perform a particular function. By way of example only, the resources accommodated by the backend server 250 may include one or more of the following software components or modules: the search engine 225 that interfaces with the web index 230 to retrieve the search results 265 that are responsive to the query 215, the editing component 235, the query categorizer 270, the rendering component 280, the user-history component 275 that interfaces with data store(s) 290, and, potentially, a taxonomy 285 of predefined categories.

The client device 210 may include an input device (not shown) and a presentation device (not shown). Generally, the input device is provided to receive input(s) affecting, among other things, a presentation of the search results in a browser window surfaced at a GUI display area. Illustrative devices include a mouse, joystick, key pad, microphone, I/O components 120 of FIG. 1, or any other component capable of receiving a user input and communicating an indication of that input to the client device 210. By way of example only, the input device facilitates entry of the query 215 and controls the location of a selection tool (e.g., mouse pointer) hovering over the search results 265 or the category 260 exposed on a homepage 280 and/or a category page 230.

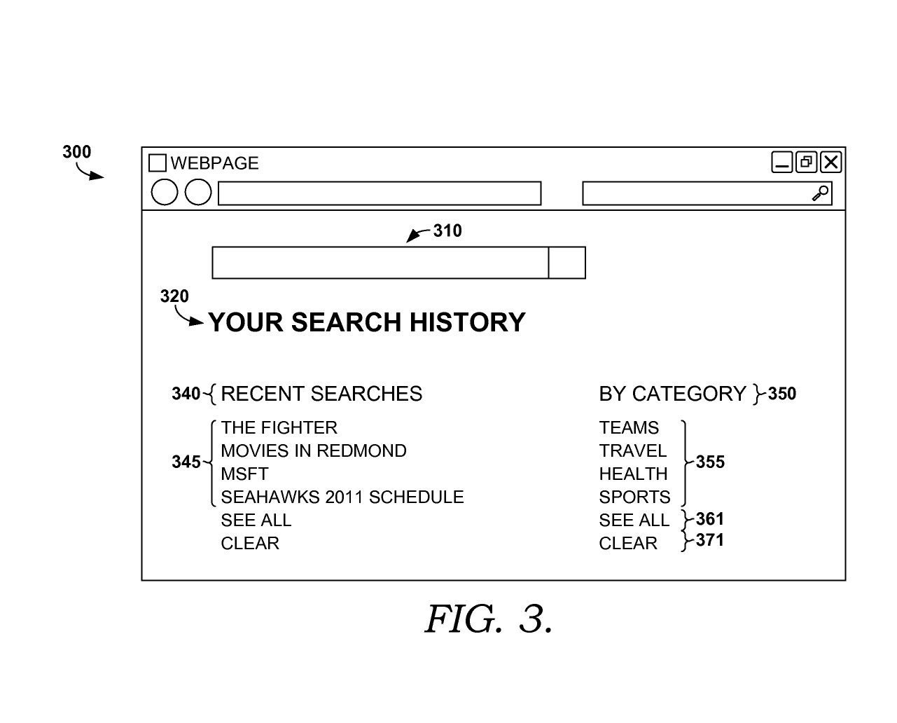

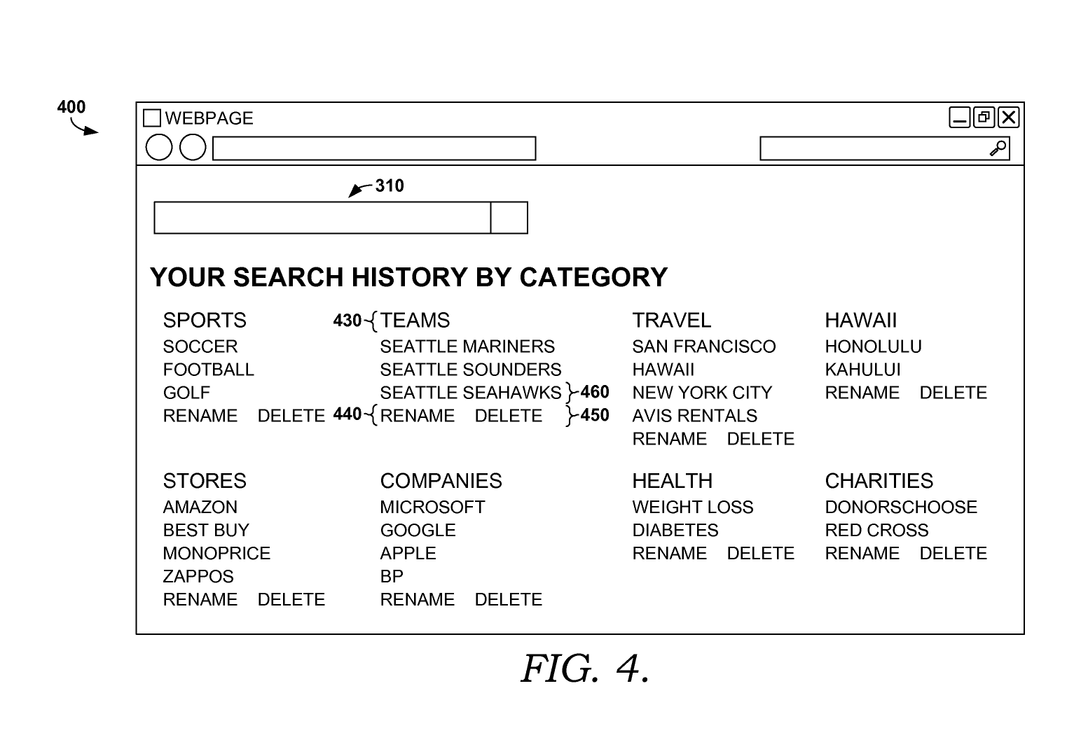

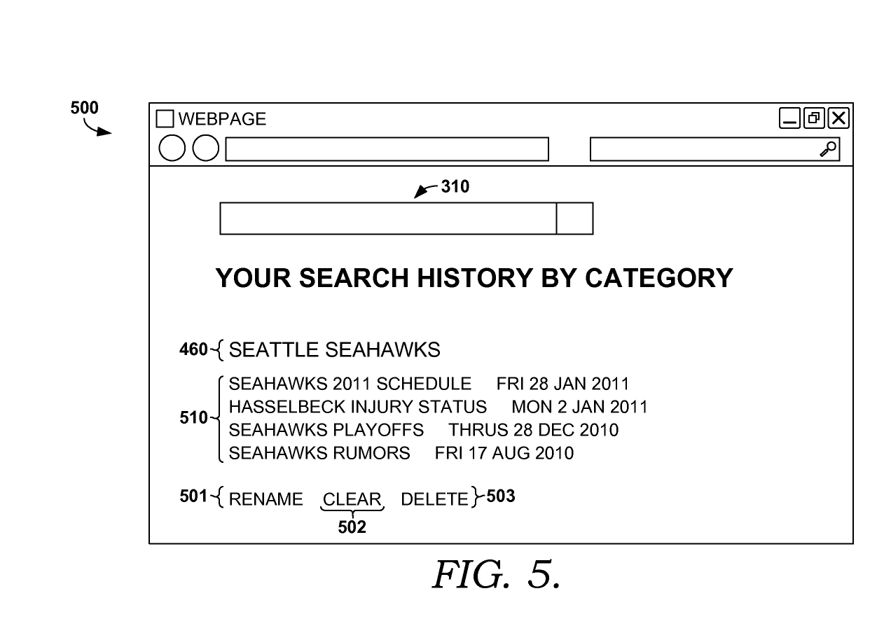

In embodiments, the presentation device is configured to render and/or present a UI display (e.g., the homepage 280 and/or the category page 230) thereon. The presentation device, which is operably coupled to an output of the client device 210, may be configured as any presentation component that is capable of presenting information to a user, such as a digital monitor, electronic display panel, touch-screen, analog set top box, plasma screen, audio speakers, Braille pad, and the like. In one exemplary embodiment, the presentation device is configured to present rich content, such as a browser window that is populated with search results 265. In another exemplary embodiment, the presentation device is capable of rendering other forms of media (e.g., audio signals). In yet another exemplary embodiment, the presentation device may present such illustrative UI displays as the homepage 300 (see FIG. 3) configured for accepting the query 215 from a user and displaying the category 260 as a link, a primary category page 400 (see FIG. 4) that includes a structure of categories distilled from the user's search history, and a secondary category page 500 (see FIG. 5) for revealing previously submitted queries in association with one of more categories that are semantically related to the queries.

The data store(s) 290 are generally configured to store information to support determination of categories and generation of a UI display that renders the determined categories in visual association with past queries. For instance, the data stores may include the log 295 that maintains a user's search history. In various embodiments, the information stored in the data store(s) 290 may also include, without limitation, metadata extracted from web pages, searching behavior tracked from a general population of users, a profile of the user that stores information (e.g., demographics, characteristics, and interests), and any other information that pertains to embodiments of the present invention.

In addition, the data store(s) 290 may be configured to be searchable for suitable access of the stored information and configured to grant write access thereto. For instance, the data store(s) 290 may be searchable for previous navigation events (e.g., queries, visited websites, clicked-through links, and URLs of online documents or web pages entered by the user) that are written to the user's search-history log 295. It will be understood and appreciated by those of ordinary skill in the art that the information stored in the data store(s) 290 may be configurable and may interact with the user-history component 275. The content and volume of such information are not intended to limit the scope of embodiments of the present invention in any way. Further, though illustrated as single, independent components, the data store(s) 290 may, in fact, be a plurality of databases, for instance, a database cluster, portions of which may reside on the client device 210, the backend server 250, another external computing device (not shown), and/or any combination thereof.

This exemplary system architecture 200 is but one example of a suitable environment that may be implemented to carry out aspects of the present invention and is not intended to suggest any limitation as to the scope of use or functionality of the invention. Neither should the illustrated exemplary system architecture 200 be interpreted as having any dependency or requirement relating to any one or combination of the client device 210, the UX layer 220, the backend server 250, the web index 230, and the data store(s) 290 as illustrated. In some embodiments, one or more of the components 225, 235, 270, 275, 280, and 285 may be implemented as stand-alone devices. In other embodiments, one or more of the components 225, 235, 270, 275, 280, and 285 may be integrated directly into the backend server 250, or on distributed nodes that interconnect to form the backend server 250. It will be understood by those of ordinary skill in the art that the components 225, 235, 270, 275, 280, and 285 (illustrated in FIG. 2) are exemplary in nature and in number and should not be construed as limiting.

Accordingly, any number of components may be employed to achieve the desired functionality within the scope of embodiments of the present invention. For instance, the taxonomy 285 of predefined categories is illustrated for purposes of description and, in reality, a multitude of similarly situated components may exist internal to and/or external of the backend server 250. Further, although the various components of FIG. 2 are shown with lines for the sake of clarity, in reality, delineating various components is not so clear, and, metaphorically, the lines would more accurately be grey or fuzzy. Further, although some components of FIG. 2 are depicted as single blocks, the depictions are exemplary in nature and in number and are not to be construed as limiting (e.g., although only log 295 is shown, many more may be maintained within the data store(s) 290).

Further, the devices of the exemplary system architecture may be interconnected by any method known in the relevant field. For instance, the backend server 250 and the client device 210 may be operably coupled via a distributed computing environment that includes multiple computing devices coupled with one another via one or more networks. In embodiments, the network may include, without limitation, one or more local area networks (LANs) and/or wide area networks (WANs). Such networking environments are commonplace in offices, enterprise-wide computer networks, intranets, and the Internet. Accordingly, the network is not further described herein.

In operation, the components 225, 235, 270, 275, 280, and 285 are designed to perform a process that is capable of matching categories to queries that are previously submitted by the user. As used herein, the term “queries” is not meant to be limiting, but may include any data entered into a search engine for the purpose of retrieving at least one search result. For instance, the query 215 may represent a search string (e.g., typed characters, numbers, symbols, terms, phrases, or any combination thereof) that is entered into a search box (e.g., see reference numeral 310 of FIGS. 3-5). In another instance, the query 215 may represent a uniform resource locator (URL) address that generates a set of search results or navigates to a search-result page previously generated by the search engine 225.

Initially, the search engine 225 is configured for crawling the Web index 230 to retrieve a plurality of search results 265. In embodiments, the web-browser application 205 running on the client device 210 is generally configured to access and communicate with the search engine 225 running on the backend server 250. For instance, access to the search engine 225 may be achieved by providing an appropriate URL address to the web-browser application 245 that targets the search engine 225. In another instance, communication may be established via an Internet (e.g., the World Wide Web) or an intranet (e.g., internal system to the communications network) connection. Once connected in operable communication, the web-browser application 245 may be configured to convey the query 215 to the search-engine component 225 and receive search results 265 in return. In an exemplary embodiment, the search engine 225 is responsible for receiving the query 215 from a web-browser application 245, generating search results 265 that are responsive to the query 215, and delivering the search results 265 to the web-browser application 245 for rendering on a search-results page.

As mentioned previously, once the user has visited the search-results page and found that one or more of the search results 265 satisfy the user's searching intent, the user may wish to memorialize the trail back to the search-results page. This trail can be captured by associating categories with the query that generated the search-results page. As used herein, the term “categories” broadly refers to any logical description. For instance, categories may be represented by individual entities, entity classes, and entity domains. In another instance, categories may be represented by actions or tasks. Further, categories may vary in the scope of subject matter that they encompass. By way of example, a general category (e.g., “soccer”) may encompass a comprehensive array of concepts or themes and may likely be represented by entity classes or entity domains, when associated with a person, place, or thing. Alternatively, a specific category (e.g., “Seattle Sounders”) may be narrowly focused on a particular topic and may likely be represented by an individual entity, when associated with a person, place, or thing.

Within the taxonomy 285, there exists various hierarchical levels generally that correspond with the breadth of the scope of the predefined categories organized therein. In embodiments, higher-hierarchical levels of the taxonomy 280 generally have a broader scope than lower-hierarchical levels. Thus, a specific category may reside at a lower hierarchical level than a general category. Further, if the categories are related, the scope of the general category may encompass the specific category.

Often, there exists a range of hierarchical levels for any logical description that may be inferred from a query. In other words, the logical description of the particular query may be encompassed by the scope of a specific category residing on a lower-hierarchical level, a general category residing on a higher-hierarchical level, and a plurality of midrange categories residing on hierarchical levels therebetween. Accordingly, when a criteria is established that requires a specific category to encompass a minimum of four queries, for example, the appropriate specific category within the taxonomy 285 may be reached by scaling upward or downward through the hierarchical levels. In a similar fashion, when a criterion is established that requires a general category to encompass a minimum of four specific categories, for example, the appropriate general category within the taxonomy 285 may be reached by scaling upward or downward to the hierarchical levels.

In an exemplary embodiment, the query categorizer 270 is responsible for interacting with the taxonomy 285 of predefined categories to automatically (implicitly) identify the category upon recognizing that sum of navigation events (e.g., queries) within a user's search history reveals interest in assigning one or more categories to a particular query. It should be noted that the query categorizer 270 is also capable of accepting manual (explicit) input from the user to select a category and establish a relationship between the selected category and a particular query. However, the functionality for automatically categorizing the users search history, or recent portion thereof, provides substantial benefits in relocating a search result without the inherent inefficiencies of manually saving information at the search engine 225.

Returning to FIG. 2, the search engine 225 is configured to passively track the queries 215 submitted by the user 210 and uses the queries 215 to update the user's log 295. By way of example, the search engine 225 may detect that the user 210 has input a search string at the search box 310 of a homepage 280 during a search session and, upon detection, automatically adds the search string to the search history of the log 295. Eventually, the memory of the log 295 may be mined by the query categorizer 270, via the user-history component 275, for selection of one or more categories 260 to be surfaced at the homepage 280, category page 230, or both. In one instance, the information within the minable memory of the log 295 may be limited to predefined time periods, such as just the ongoing search session, the last N-number of search sessions, the last N-number of queries, a one-year expiration attached to queries individually, and the like.

Automatically, and without any user initiation, the query categorizer 270 extracts queries from the search history of the minable memory of the log 295 and attempts to generate a structure of categories that substantially reflects the underlying semantic meaning of the extracted queries. In an exemplary embodiment, the query categorizer 270 employs at least one categorization process to assign category(s) to a portion of the extracted queries. In one instance of the categorization process, one or more of the following steps are taken: parsing search terms of an extracted query to distill keywords (i.e., topic inherent to the extracted query) therefrom; selecting at least one abstract object (e.g., individual entity, entity class, entity domain, and the like) from a library that semantically represents the keywords; identifying one or more categories (e.g., specific category and general category) whose scope encompasses the selected abstract object; and generating a mapping between the extracted query and the identified category(s). This mapping may be maintained within the log 295 of the user's search history or at another accessible location, such as an online user profile, for easy future reference when rendering a UI display using the UX layer 220.

In another instance of the categorization process, both a specific category and a general category are identified as topically matching, or exhibiting a semantically common concept, as the extracted query. In a particular embodiment, the steps carried out by this instance of the categorization process include the following: extracting the query from within the log 295 of a user's search history; parsing the targeted query to infer a logical description underlying the targeted query; comparing the inferred logical description of the targeted query against a taxonomy of categories; identifying a specific category that is semantically related to the inferred logical description of the targeted query; and identifying a general category that is semantically related to the inferred logical description of the targeted query. As mentioned above, the identified specific category narrowly encompasses the semantic meaning of the extracted query while the general category broadly encompasses the semantic meaning of the extracted query. This is because the general category resides at a higher, or more comprehensive, hierarchical level within the taxonomy 285 than the specific category.

In embodiments, the query categorizer 270 may be configured to enumerate a number of the additional queries (e.g., within the mineable memory of the log 295) mapped to the identified specific category and expand the scope of the specific query to meet a minimum-threshold criteria, if actively imposed. As discussed above, the minimum-threshold criteria dictates the minimum number of queries whose semantic meaning is encompassed by the specific criteria. If the minimum-threshold criteria is not satisfied, the scope of the specific category is incrementally expanded by moving upward through the hierarchical levels of the taxonomy 285 until the number of queries matched to the specific query satisfies the minimum-threshold criteria. At this point, query categorizer 270 is configured to permit the specific category to be rendered. As such, embodiments of the present invention allow for intelligently selecting a hierarchical level associated with a subject category such that the threshold number of queries that relate to the subject category may be overcome while still mapping a particular query to the subject category.

The rendering component 280, in embodiments, is generally responsible for rendering one or more queries in visual association with the identified specific category (e.g., see FIG. 5). In other embodiments, the rendering component 280 is responsible for rendering a plurality of specific categories in visual association with the identified general category (e.g., see FIG. 4). In still other embodiments, the rendering component 280 is possible for rendering a plurality of general categories in visual association with a heading labeled “categories.” The UX layer 220 assists the rendering component 280 by applying various rules to the presentation of the categories and/or the queries. By way of example, these rules might affect such interfacing aspects as the quality and quantity of queries that may appear underneath a specific category, the quality and quantity of the specific categories that may appear underneath a general category, the composition of the links that are attached to the queries in the categories, the formatting of the UI displays (e.g., font, positioning, layout, ordering, and the like), and the wording of the headers to introduce the UI displays.

In embodiments, the rendering component 280 is configured to organize on a UI display the categories based on a variety of parameters. For example, a parameter that governs relevance of the categories may instruct the rendering component 280 to withhold surfacing the category that is mapped to older queries. Or, the parameter governing relevance may instruct the rendering component 280 to rank categories that are mapped to newer queries higher than those categories that are mapped to older queries, where the high-ranking categories may be surfaced on the UI display first and in a more prominent position. Another example a parameter that governs popularity of the categories may instruct the rendering component to withhold surfacing a category that is mapped to a lesser quantity of queries (e.g., below or just above the minimum-threshold criteria). Or, the parameter governing popularity may instruct the rendering component 280 to rank categories that are mapped to a large amount of queries higher than those categories that are mapped to fewer queries, where the high-ranking categories may be allocated substantial amount of display area or exposed on the home page.

Turning now to FIGS. 3-5, a user workflow for drilling down through a structure of categories to a targeted query will now discussed. Generally, the workflow is defined by logical progression from FIG. 3 to FIG. 4 to FIG. 5. Specifically, the logical progression involves a first user-initiated selection directed at the header “by category” 350 of FIG. 3 that invokes a navigation to the UI display (primary category page) of FIG. 4, and a second user-initiated selection directed at the specific category “Seattle Seahawks” 460 that invokes a navigation to the UI display (secondary category page) of FIG. 5. The UI display of FIG. 5 illustrates a listing 510 of links that represents queries.

The workflow might continue upon detecting a third user-initiated selection directed at one of the links within the listing 510. This third user-initiated selection may navigate the user to a search-results page. In an exemplary embodiment, the user is allowed to toggle between a current mode and a historic mode prior to actuating one of the links within the listing 510. Upon the user electing the historic mode and directing a selection-action toward a link within the listing 510, the user may be navigated to an original search-results page that was initially accessed by the user when first entering a query or represented by the selected link within the text box 310. Alternatively, upon the user electing the current mode and directing a selection-action toward a link within the listing 510, the user may be navigated to an update search-results page that shows current search results as if the query was presently entered within the text box 310. Typically, the updated search-results page varies in content from the original search-results page.

Referring now to FIG. 3, a schematic diagram depicting a first illustrative UI display of a homepage 300 configured for accepting a query from a user is shown, in accordance with embodiments of the invention. Initially, it should be noted that the header 350 and the listing 355 of links that represent general categories act as an entry point to the category structure that operates to guide the user to a forgotten query for valuable search result(s). However, other entry points to the category structure are contemplated in the present invention. For example, entry points may include links within menus or modules of a search-results page, links provided within a drop-down menu from the text box 310, and links displayed in a pop-up menu while the user is conducting a search session.

Returning to FIG. 3, the homepage 300 is advertised with a main header “your search history” 320 that purports to include information particular to the user. This information includes a listing 345 of links to recent searches, a header “recent searches” 340 that navigates to a robust UI display of recent searches, the listing of links to general categories 355, and the header “by category” 350 that navigates to a robust UI display of categories mapped to queries pulled from the user's search history, as described above. Controls 361 and 371 act to amend the general-category links within the listing 355 (e.g., using the editing component 235 of FIG. 2). Accordingly, the user is enabled to delete or see more general-category links upon selecting the controls 361 and 371, respectively.

With reference to FIG. 4, a schematic diagram depicting a second illustrative UI display of a primary category page 400 showing a taxonomy of categories is shown, in accordance with embodiments of the invention. The primary category page 400 includes a layout of general-category headers, such as the header “teams” 430, in visual association with specific-category links, such as link “Seattle Seahawks” 460. Controls 440 and 450 act to amend the specific-category links under the respective headers (e.g., using the editing component 235 of FIG. 2). Accordingly, the user is enabled to rename or delete individual specific-category links upon selecting the controls 440 and 450, respectively.

With reference to FIG. 5, a schematic diagram depicting a third illustrative UI display of a secondary category page 500 showing queries in visual association with a category is shown, in accordance with embodiments of the invention. The second category page 500 shows the listing 510 of links to queries. The context of the queries is provided by the header “Seattle Seahawks” 460, which doubles as a specific-category link from the primary category page 400. Controls 501, 502, and 503 act to amend the queries (e.g., using the editing component 235 of FIG. 2). Accordingly, the user is enabled to rename, clear, or delete individual queries upon selecting the controls 501, 502, and 503, respectively.

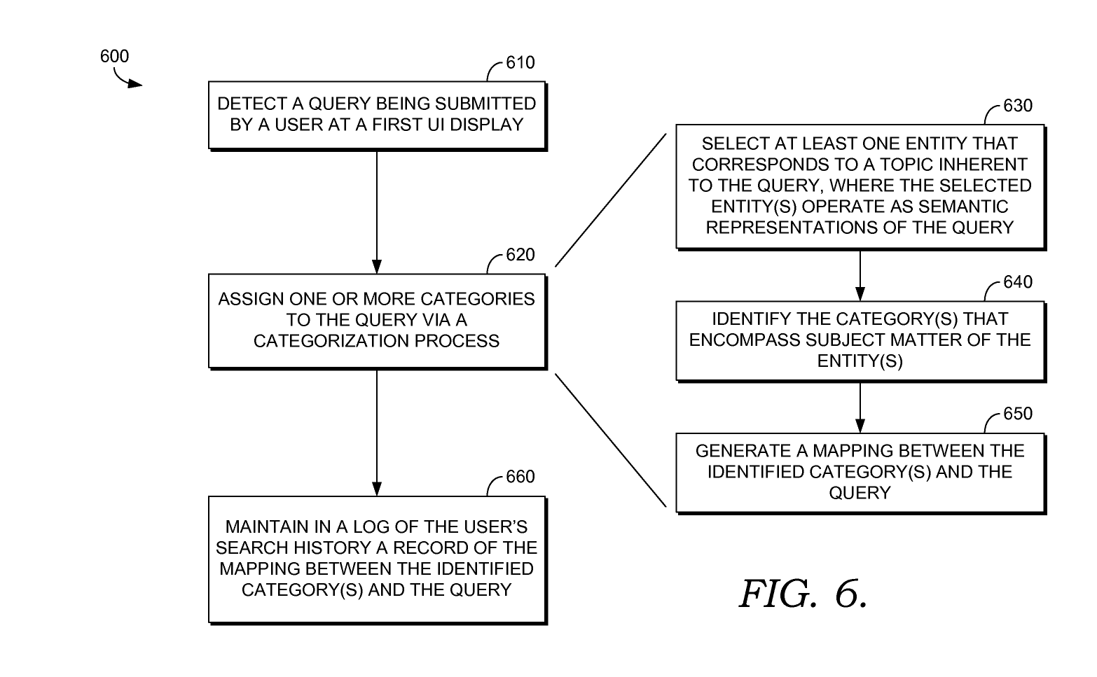

Turning now to FIG. 6, a flow diagram illustrating an overall method 600 for mapping a query to a category is shown, in accordance with an embodiment of the present invention. Although the terms “step” and/or “block” may be used herein to connote different elements of methods employed, the terms should not be interpreted as implying any particular order among or between various steps herein disclosed unless and except when the order of individual steps is explicitly described. Initially, as more fully described above, the method 600 at block 610 involves detecting the query being submitted by a user at a first UI display.

As more fully discussed above with reference to FIG. 2, the query may be assigned one or more categories via a categorization process, as depicted at block 620. In one embodiment, the categorization process involves at least the following steps: selecting at least one entity that corresponds to a topic inherent to the query (see block 630), identifying the category(s) that encompass subject matter of the entity(s) (see block 640), respectively; and generating a mapping between the identified category(s) and the query (see block 650). Typically, the entity(s) operate as a semantic representation of the query. The method 600 may further involve maintaining in a log of the user's search history a record of the mapping between the identified category(s) and the query at block 660.

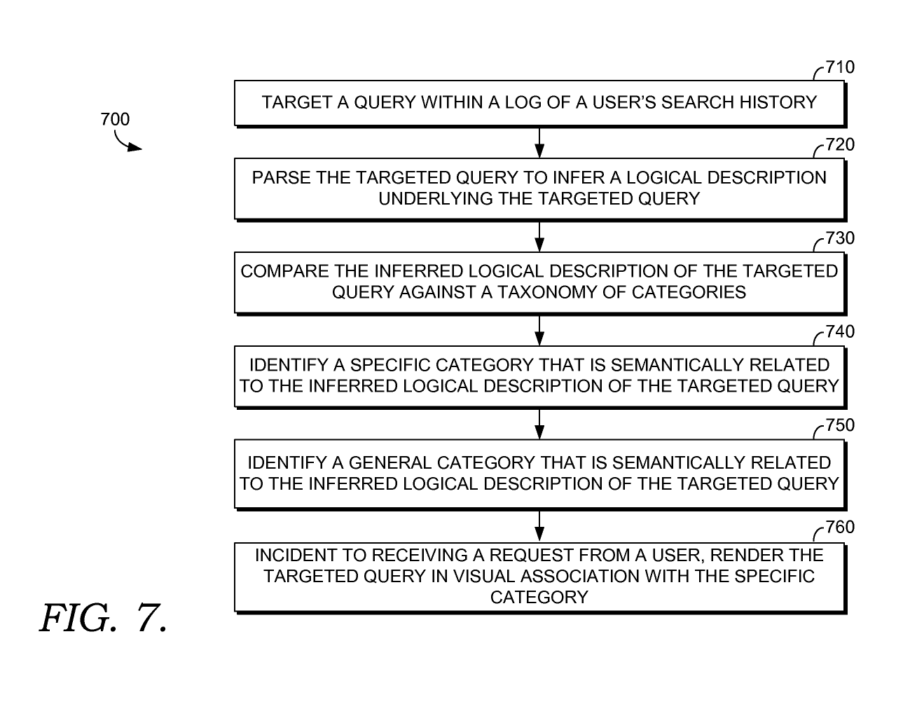

With reference to FIG. 7, a flow diagram illustrating an overall method 700 for presenting one or more categories in visual association with a query on a UI display is shown and will now be discussed in accordance with an embodiment of the present invention. As indicated at blocks 710 and 720, the method 700 includes the steps of targeting the query within a log of a user's search history and parsing the targeted query to infer a logical description underlying the targeted query. In operation, as depicted at block 730, the inferred logical description of the targeted query may be compared against a taxonomy of categories.

Upon comparison, as depicted at block 740, a specific category may be identified that is semantically related to the inferred logical description of the targeted query. Further, as depicted at block 750, a general category may be identified that is also semantically related to the inferred logical description of the targeted query. However, the general category typically resides at a different hierarchical level within the taxonomy than the specific category. The method 700 may further include at block 760, incident to receiving a request from a user, rendering the targeted query in visual association with the specific category.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

What is claimed is:

1. One or more computer-storage media having computer-executable instructions embodied thereon that, when executed, perform a method for mapping a query to a category, the method comprising:
detecting the query being submitted by a user at a first UI display;
assigning one or more categories to the query via a categorization process comprising;
(a) selecting at least one entity that corresponds to a topic inherent to the query, wherein the at least one entity operates as a semantic representation of the query;
(b) identifying the one or more categories that encompass subject matter of the at least one entity, respectively; and
(c) generating a mapping between the one or more identified categories and the query;
maintaining in a log of the user's search history a record of the mapping between the one or more identified categories and the query.

2. The media of claim 1, wherein the method further comprises receiving an indication to launch a second UI display.

3. The media of claim 2, wherein the method further comprises rendering the one or more identified categories as one or more links, respectively, within the second UI display.

4. The media of claim 3, wherein the first UI display represents a homepage for accepting the query within a search box, and wherein the second UI display represents a primary category page that exposes a predefined number of recently or frequently searched categories.

5. The media of claim 4, wherein the method further comprises receiving an indication to launch a third UI display, wherein the third UI display represents a secondary category page that exposes the query as a link.

6. The media of claim 5, wherein the method further comprising, upon detecting the query being submitted by the user at the first UI display, navigating the user to an original search-results page.

7. The media of claim 6, allowing the user to toggle between a current mode and a historic mode when visiting the second UI display.

8. The media of claim 7, wherein the method further comprises, upon the user electing the historic mode and directing a selection-action toward the exposed query on the third UI display, navigating the user to the original search-results page.

9. The media of claim 8, wherein the method further comprises, upon the user electing the current mode and directing a selection-action toward the exposed query on the third UI display, navigating the user to an updated search-results page that varies in content from the original search-results page.

10. The media of claim 1, wherein the method further comprises exposing the one or more identified categories within the first UI display.

11. A computerized method, carried out by a processing unit, for presenting one or more categories in visual association with a query on a UI display, the method comprising:
targeting the query within a log of a user's search history;
parsing the targeted query to infer a logical description underlying the targeted query;
comparing the inferred logical description of the targeted query against a taxonomy of categories;
identifying a specific category that is semantically related to the inferred logical description of the targeted query;
identifying a general category that is semantically related to the inferred logical description of the targeted query, wherein the general category resides at a different hierarchical level within the taxonomy than the specific category; and
incident to receiving a request from a user, rendering the targeted query in visual association with the specific category.

12. The method of claim 10, wherein a scope of the specific category narrowly encompasses the inferred logical description of the targeted query.

13. The method of claim 10, wherein a scope of the general category broadly encompasses the inferred logical description of the targeted query.

14. The method of claim 10, further comprising rendering the specific category in visual association with the general category.

15. The method of claim 10, further comprising mapping additional queries mined from a memory of the user's search-history log to the specific category.

16. The method of claim 15, further comprising enumerating a number of the additional queries mapped to the specific category.

17. The method of claim 16, further comprising permitting the specific category to be rendered upon the number of the additional queries mapped to the specific category overcoming a predefined threshold.

18. The method of claim 17, adjusting the number of additional queries that are accessible within the minable memory of the user's search-history log in accordance with predefined expiration periods associated with the additional queries, respectively.

19. A computer system for recognizing and presenting one or more categories that capture a semantic meaning of a query, the computer system comprising a processing unit coupled to a computer storage medium, the computer storage medium having stored thereon a plurality of computer software components executable by the processing unit, the computer software components comprising:
a query categorizer for selecting the one or more categories that are associated with the query received from a user, wherein the one or more selected categories include a specific category that narrowly encompasses the semantic meaning of the query and a general category that broadly encompasses the semantic meaning of the query;
a rendering component for determining whether to present the one or more selected categories as a function of a number of queries that are previously associated therewith;
a user experience layer for presenting a representation of the query in conjunction with the one or more selected categories at a category page upon determining that the number of queries that are previously associated with the one or more selected categories overcomes a predefined threshold, wherein the query representation includes a link that, when actuated, navigates the user to a search-results page.

20. The computer system of claim 19, the computer software components further comprising an editing component for allowing the user to add, delete, and alter the queries previously associated with the one or more selected categories.
